(19) United States
(12) Patent Application Publication
(10) Pub. No.: US 2015/0021522 A1
(43) Pub. Date: Jan. 22, 2015

(54) METHOD AND DEVICE FOR PRODUCING A KRYPTON/XENON MIXTURE

(71) Applicants: Vitaly Leonidovich Bondarenko, Moscow (RU); Nikolay Petrovich Losyakov, Moscow (RU); Valeriy Borisovich Vorotyntsev, Balashiha (RU); Aleksandr Petrovich Grafov, Balashiha (RU)

(72) Inventors: Vitaly Leonidovich Bondarenko, Moscow (RU); Nikolay Petrovich Losyakov, Moscow (RU); Valeriy Borisovich Vorotyntsev, Balashiha (RU); Aleksandr Petrovich Grafov, Balashiha (RU)

(21) Appl. No.: 14/345,045

(22) PCT Filed: Sep. 14, 2012
(86) PCT No.: PCT/RU2012/000762

§ 371 Date: Oct. 9, 2014

(30) Foreign Application Priority Data
Sep. 15, 2011 (RU) 2011137842

(51) Int. Cl. C01B 23/00; B01J 7/00

(52) U.S. Cl. CPC C01B 23/0094; B01J 7/00
USPC 252/372; 422/187

(57) ABSTRACT

The invention relates to inert gas production processes and can be used for producing a krypton/xenon mixture from a stream of oxygen recovered from air separation plants and containing 0.05-0.5% krypton and xenon. The method for producing a krypton/xenon mixture involves purifying a stream of gaseous primary concentrate by the catalytic combustion thereof and subsequently cooling same, purifying the primary concentrate of catalytic combustion products, carrying out cooling upon completion of purification, fractionating the primary concentrate in a rectification column to form a stream of krypton/xenon mixture and a stream of stripped oxygen and removing the stream of krypton/xenon mixture from the rectification column in the form of a target product, as well as purifying the krypton/xenon mixture of radon. The invention makes it possible to extend the scope of use of the krypton/xenon mixture.

The invention relates to inert gas production processes and can be used for producing a krypton/xenon mixture from a stream of oxygen recovered from air separation plants and containing 0.05-0.5% krypton and xenon.

### PRIOR ART

A known method for producing a krypton/xenon mixture comprises feeding a primary concentrate stream from the ASU to the primary concentrate line, purification of the primary concentrate front hydrocarbons in the catalytic combustion unit and cooling the primary concentrate stream in the aftercooler, purification of the primary concentrate stream from the catalytic combustion products in the adsorption purification unit followed by the formation of the purified concentrate stream, cooling: the purified concentrate stream in the main heat exchanger, and feeding the purified concentrate stream to the rectification column for fractional separation of the said stream in the contact portion of the rectification column to form a krypton/xenon stream and a stream of stripped oxygen, feeding the stripped oxygen stream from the rectification column to the stripped oxygen line, feeding the krypton/xenon mixture stream from the rectification column to the line of the product mixture, feeding liquid nitrogen to the boiling side of the rectification column condenser, evaporation of said stream on the boiling side of the rectification column condenser followed by the formation of the gaseous nitrogen stream, feeding said stream to the line of gaseous nitrogen return stream, feeding incoming air stream to the line of the incoming air stream, feeding the air stream to the coil of the rectification column bottom, and withdrawal of the return air stream from the coil in the rectification column bottom in the line of the return air stream [catalog Cryogenic Equipment, part 2, Tsintihimneftemash, M., 1976, p. 75].

The disadvantage of this method is its relatively low reliability and safety, as well as low thermodynamic efficiency because before the concentrate stream, which is, actually, pure oxygen is passed through the unit, it is pre-compressed in the compressor to the pressure of 4-6 atm.

Another method for producing a krypton/xenon mixture comprises feeding a primary concentrate to the primary concentrate line, heating the primary concentrate by a return stream in a high-temperature recuperative heat exchanger, increase of temperature to the required one in the heater, feeding to the reactor inlet to activate the reaction of catalytic oxidation of hydrocarbons, cooling by the direct stream in the high-temperature recuperative heat exchanger, purification by adsorption, condensation and hydrostatical pressure increase at the downflow movement of the condensed stream of the purified primary concentrate, evaporation at the end of the downflow movement in the condenser-evaporator using condensed air as a condensing medium and feeding to the rectification column with acquisition of a krypton/xenon mixture in the bottom; moreover, gas blower is installed at the beginning of the primary concentrate line; a portion of the primary concentrate is withdrawn from the primary concentrate line and fed to the reactor inlet. Heat-conductive medium is additionally applied to the reactor; contact mass of the catalytic agent is distributed along the reactor vertical channels and it is formed of, at least, two layers with different temperatures at the beginning of the oxidation reaction and thermal resistance, providing thermal interference of an individual layer with the heat-conductive medium; after regeneration, adsorbers are blown by the flow of oxygen; the primary concentrate stream in the primary concentrate line is mixed with as portion of the purified primary concentrate removed from the column flow feed line; evaporation of the liquid primary concentrate is implemented in the ascending direct flow, at least, in a two-step process: a major mass of the liquid is evaporated in the condenser-evaporator, and the remaining portion of the liquid, withdrawn at the outlet from the heat-exchanging surface of the condenser evaporator, on the auxiliary evaporator; in the process, the air flow directed for condensation to the condenser-evaporator is mixed with oxygen stream [RU 2008126533, C3, F25J3/00, B01D53/02, 2 Jul. 2008].A disadvantage of this method is also its low reliability and safety, since before the oxygen stream is passed through the device, it must be pre-compressed in the gas blower.

In another known method of producing a krypton/xenon mixture, a primary concentrate with the total content of krypton and xenon 0.01÷1.5%, containing hydrocarbons up to 0.6%, nitrogen 0.5÷50% and oxygen being the remaining portion goes through the catalyst layer at a temperature 380÷470° C., and a feed space velocity 2000÷15000 hr⁻¹, at which a catalytic oxidation of hydrocarbons occurs to their content not exceeding 3 ppm; then it undergoes adsorption purification from water vapor and carbon dioxide and rectification with the extraction of a krypton/xenon mixture from the primary krypton concentrate; in the process, oxidation of hydrocarbons occurs on the catalyst containing 5-20 weight of manganese dioxide applied to Zirconium oxide carrier, and a krypton/xenon mixture is extracted by using upper cold reflux in the form of liquid nitrogen or liquid oxygen taken in the amount from 10 to 40% of the feedstock [RU2375299, C2, F25J13/00, 1301D53/02, l8 Feb. 2008].

The disadvantages of this method are its relatively low safety, since for its implementation it is also necessary to use a compression apparatus (compressor), and also the fact that the elimination of the condenser in the rectification column only slightly reduces the size of the column, but simultaneously leads to the fact that in case of using liquid nitrogen as an upper reflux, it becomes impossible to return the stripped oxygen to the ASU, and in case of using liquid oxygen in this capacity, operating costs increase considerably. Furthermore, to significantly improve the recovery ratio of the product, the fraction of the introduced liquid reflux, as it follows from the examples illustrating the process, will be greater than the claimed 40% of the feedstock.

The closest in its technical essence to the proposed method is the method for producing a krypton/xenon mixture comprising feeding a primary concentrate stream to the primary concentrate line, purification of the primary concentrate stream in the pre-purification unit, cooling the primary concentrate stream in the aftercooler, purification of the primary concentrate stream in the adsorption purification unit followed by formation of a purified concentrate stream, feeding said stream to the purified concentrate line, cooling the purified concentrate stream in the main heat exchanger, feeding said stream to the rectification column to the line of the separating stream feed, fractional separation of said stream in the contact section of the rectification column with the formation of a stream of krypton/xenon mixture and a stream of stripped oxygen, feeding the stream of stripped oxygen from the rectification column to the stripped oxygen line, feeding return oxygen stream to the return oxygen line, feeding the stream of krypton/xenon mixture from the rectification column to the line of the production mixture, feeding the incoming liquid nitrogen to the incoming line of liquid nitrogen, feeding the first stream of liquid refrigerant to the rectification column condenser on the boiling side in the line of the first stream of liquid refrigerant, evaporation of said stream in the rectification column condenser on the boiling side with the formation of the first stream of gaseous refrigerant, feeding said stream to the line of the first gaseous refrigerant stream, feeding the first gaseous refrigerant stream to the return nitrogen line, feeding the incoming air stream to the incoming air stream line and withdrawal of the return air stream in the return air stream line; in addition, the purified concentrate stream after its cooling in the main heat exchanger is liquefied in the columnar condenser on the condensation side, and then it is fed to the columnar line as a liquefied concentrate stream, where a preliminary pressure increase of the liquefied stream is carried out; then the liquefied concentrate stream, as an incoming low head liquid flow, is fed from the columnar line to the intake line of the pressure boost stage, where said stream is transformed into an intermediate two-phase stream in the device for the intermediate two-phase stream: after that, the stream is raised through the pull line, in which the potential energy of the intermediate two-phase stream is increased, to the high potential vapor separator of the pressure boost stage, where the liquid and the gaseous phases are separated; the gaseous phase from the high potential vapor separator is withdrawn from the pressure boost stage and as a return stream of the concentrate through the takeoff line and the takeoff flow control valve is fed to be mixed with the stream of the purified concentrate before liquefaction of the latter in the columnar condenser on the condensation side; the liquid phase from the high potential vapor separator of the pressure boost stage passes through the pressure line of the pressure boost stage where occurs the outgoing pressure buildup of the liquid concentrate stream due to gravity; then it is fed through the outlet valve of the pressure boost stage as a liquid stream of high head of the pressure boost stage to the line of high head of the pressure boost stage; after that said stream as a high head liquid concentrate stream goes to the condenser-evaporator in the high head liquid concentrate flow line where said stream is gasified, and as a stream for separation, it is fed to the rectification column in the stream for separation feed line [RU 2149676, C1, B01D53/00, F25J3/02, 27 May 2000].

Furthermore, in the known method, the incoming air feed stream is divided into parts: the warming air stream and the stream of air refrigerant; the incoming stream of liquid nitrogen is divided into the first stream of liquid refrigerant and the columnar stream of liquid nitrogen. In the process, the air-refrigerant stream is fed to the line of air-refrigerant stream, then it is pre-cooled in the auxiliary heat exchanger and after that it is liquefied in the condenser-evaporator and in the form of liquid air stream in the line of liquid air stream, it is fed through the air vapor separator and the liquid air valve to the line of the second stream of liquid refrigerant where the liquid air stream is mixed with the columnar stream of liquid nitrogen after which the total flow in the form of the second stream of the liquid refrigerant goes to the columnar condenser on the boiling side where it is evaporated with the formation of the second stream of the gaseous refrigerant, after which the latter stream is fed to the line of the second stream of the gaseous refrigerant, heated in the main heat exchanger, mixed with the warming air feed stream with the formation of the return air stream. Then said stream is additionally heated in the aftercooler and fed to the line of the return air stream. In addition, the stripped oxygen stream after being withdrawn from the rectification column is additionally subsequently heated in the additional heat exchanger and the aftercooler and then in the form of the return oxygen fed to the line of the return oxygen stream, and the first stream of the gaseous refrigerant prior to its feed to the return nitrogen line is also additionally subsequently heated in the additional heat exchanger and the aftercooler. In addition to this, in the closest technical solution, a stream for separation before being fed to the rectification column is additionally purified from radon in the radon adsorber.

The disadvantage of the closest technical solution regarding the method is its relatively narrow range of application because it can be used to obtain a krypton/xenon mixture from the gaseous stream of primary concentrate, but in practice we often have to deal with the sources of primary concentrate in a liquid form. Furthermore, in the process of pressure increase by a columnar condenser, air is used as a refrigerant which does not allow processing the primary concentrate which has nitrogen in its composition in amounts greater than 5% of the initial composition. This also restricts the scope of application of the known method. Partial purification from radon before feeding to the rectification column, which is undoubtedly less effective than purification in the finished product, also restricts the scope of application. This requires extra expenditures to compensate for losses of cold generated during the operation at a large-sized device, and also to overcome real challenges in utilizing it together with the sorbent (weight of such adsorber exceeds one ton).

Thus, the closest technical solution regarding the method cannot be effectively used when the primary concentrate is in a liquid state and has high nitrogen content.

The required technical result of the method consists in extending the scope of its application.

Devices for producing, a krypton/xenon mixture from the primary krypton concentrate are also known.

One of the known devices includes a gasholder for collecting the primary concentrate from the ASU, a piston compressor with the pressure up to 6 bar, a unit for primary burning out hydrocarbons, consisting of two parallel furnaces with a catalyst inside, a heat exchanger, a water cooler, an adsorption purification unit consisting of two zeolite adsorbers working in turns, a secondary concentration unit, consisting of a rectification column and a nitrogen heat exchanger, a unit for a secondary burning of hydrocarbons, comprising a cartridge with a copper oxide, a small adsorber for purification from the products of secondary burning, a rigid gasholder for collecting a krypton/xenon mixture, a gas generator and a filling ramp with cylinders filled with the produced krypton/xenon mixture [Catalogue Cryogenic Equipment, part two, Tsintihimneftemash, M., 1976, page 75].

The disadvantage of this device is relatively high energy consumption to produce the product due to the presence of a piston compressor in the circuit, a low degree of hydrocarbon burning due to the use of the inefficient catalyst in the furnaces of the first stage burning, as well as the circumstance that it fails to ensure a low radiation factor in the useful output product caused by a relatively high presence of radon in it.

The closest to the technical nature of the proposed device for producing a krypton/xenon mixture from a primary concentrate is a solution comprising a primary concentrate line with a pre-purification unit mounted on it, an aftercooler and an adsorption purification unit connected with the line of primary concentrate, a line of purified concentrate with the main heat exchanger mounted on it, an incoming, liquid nitrogen line, a line of the incoming air stream, a line of the heating air stream connected with the incoming air stream tine by the inlet, a rectification column comprising a rectification column condenser, as contact portion of the rectification column and a rectification column evaporator, a stream for separation feed line and a stripped oxygen line, both connected to the rectification column, a line of the production mixture connected to the rectification column condenser on the boiling side and an incoming liquid nitrogen, the first stream of liquid refrigerant line connected to the rectification column condenser on the boiling side, the first stream of gaseous refrigerant, a line of the return nitrogen stream, a line of the return oxygen stream, and a line of the return air stream, connected in sequence by the columnar condenser, by the columnar line, the intake line of the pressure boost stage, a unit for an intermediate two-phase stream formation, a pulling line, a high potential evaporator, a pressure line of the pressure boost stage with the outlet valve of the pressure boost stage, a high head line of the pressure boost stage, a high head liquid concentrate line with the condenser-evaporator located on it; furthermore, the columnar condenser on the condensation side is connected to the purified concentrate line after the main heat exchanger, and the line of the high head liquid concentrate is connected to the line of the stream for separation feed line after the condenser-evaporator. In the process, a high potential vapor separator of the pressure boost stage is additionally connected through a takeoff line with a takeoff flow control valve mounted on it to the purified concentrate line before the columnar condenser and also additionally connected to the receiving line of the pressure increase stage before the unit of the intermediate two-phase stream formation by two parallel lines: liquid make up line and a regulating line with a control valve and a low potential vapor separator of the pressure boost stage installed on the latter [RU 2149676, C1, B01D53/00, F25J3/02, 27 May 2000].

Furthermore, the closest device is additionally supplied with subsequently installed: an air refrigerant stream line with an additional heat exchanger located on it; a liquid air stream line with an air vapor separator and liquid air valve located on it, connected with the line of the air refrigerant stream through the condenser-evaporator; a line of the second stream of the liquid refrigerant connecting the line of the liquid air stream to the columnar condenser on the boiling side and additionally connected to the incoming liquid nitrogen line by means of the liquid nitrogen columnar stream feed line with the columnar nitrogen valve located on it; line of the second stream of gaseous refrigerant connecting the columnar condenser on the boiling side through the main heat exchanger and aftercooler to the line of return air stream; in the process, the line of the second stream of gaseous refrigerant is additionally connected to the outlet of warming air stream line before the aftercooler, and the line of the air refrigerant stream is connected with its inlet to the incoming air stream line; line of the first stream of gaseous refrigerant is connected to the line of the return nitrogen stream through an additional heat exchanger and an aftercooler, and the line of stripped oxygen is connected to the line of return oxygen flow through an additional heat exchanger and an aftercooler. It can be additionally supplied with an ejector line, connected through its inlet to the line of the second stream of the gaseous refrigerant after the main heat exchanger; columnar ejector and a blowdown line and the inlet of the columnar ejector is connected to the ejector line through the ejector valve; outlet of the columnar ejector is connected to the blowdown line and an injection tube of the columnar ejector is connected to the columnar condenser on the condensation side by means of the injection line with an injection valve located on it, and it is also additionally provided with a radon adsorber located on the separating stream feed line.

The disadvantage of the closest technical device for producing a krypton/xenon mixture is its relatively narrow functional capabilities, because, in spite of the considerable complexity of the design associated with utilization of a pressure boost unit using a hydraulic column of liquid, it does not allow processing the primary concentrate with a high content of nitrogen in it, and inefficiently produces product purification from radon using an adsorber installed as it is installed in a non-optimal site.

Besides, the device cannot be used to obtain a krypton/xenon mixture when the primary concentrate is liquid. It reduces the possibility of using the device for the processing of liquid primary concentrate with a high content of nitrogen in it.

A required technical result regarding the device is to extend functional capabilities by providing its use for processing liquid primary concentrate with a high content of nitrogen in it.

### PATENT DISCLOSURE

The required technical result regarding the method is achieved by the fact that, in the method for producing a krypton/xenon mixture comprising a gaseous primary concentrate purification by catalytic burning, followed by cooling, purification from the catalytic burning products, cooling after the purification by catalytic burning, fractional separation in a rectification column to form a stream of a krypton/xenon mixture and a stripped oxygen stream; extraction of the krypton/xenon mixture stream from the rectification column as a target product and also purification of the krypton/xenon mixture from radon; the stream of a gaseous primary concentrate is formed from the liquid primary concentrate coming from its sources by way of pouring the liquid primary concentrate into a storage tank Mowed by a subsequent feed from it under pressure to the vapor heat exchanger for evaporation by means of water vapor and formation of a gaseous primary concentrate; the pressure under which the liquid primary concentrate is fed to the heat exchanger is set to the value sufficient for the implementation of the further steps required for producing the target product; liquid nitrogen is used as a refrigerant for separation in the rectification column, and purification of the krypton/xenon mixture from radon takes place at the stage of its exit from the rectification column.

The required technical result regarding the device is achieved by the fact that in the device comprising a receiver, a hydrocarbon combustion unit, a water heat exchanger-cooler, a unit for adsorption purification front combustion products, a main heat exchanger, a recuperative heat exchanger of outgoing streams, a nitrogen separator, an oxygen separator, a rectification column and a radon adsorber connected by lines to shutoff, control and safety relief valves, there has been introduced a storage tank for liquid primary concentrate connected through the vapor heat exchanger with the receiver; besides, the radon adsorber is installed at the exit of the rectification column, and liquid nitrogen is used as a refrigerant.

Furthermore, the required technical result is achieved by the fact the storage tank of the liquid primary concentrate is made in the form of four reservoirs connected through a corresponding valve to the inlet of the heat exchanger.

Furthermore, the required technical result is achieved because activated carbon or silica gel or aluminum oxide or zeolite NaX is used as a radon entrapping sorbent in the radon adsorber.

### DESCRIPTION OF THE DRAWINGS

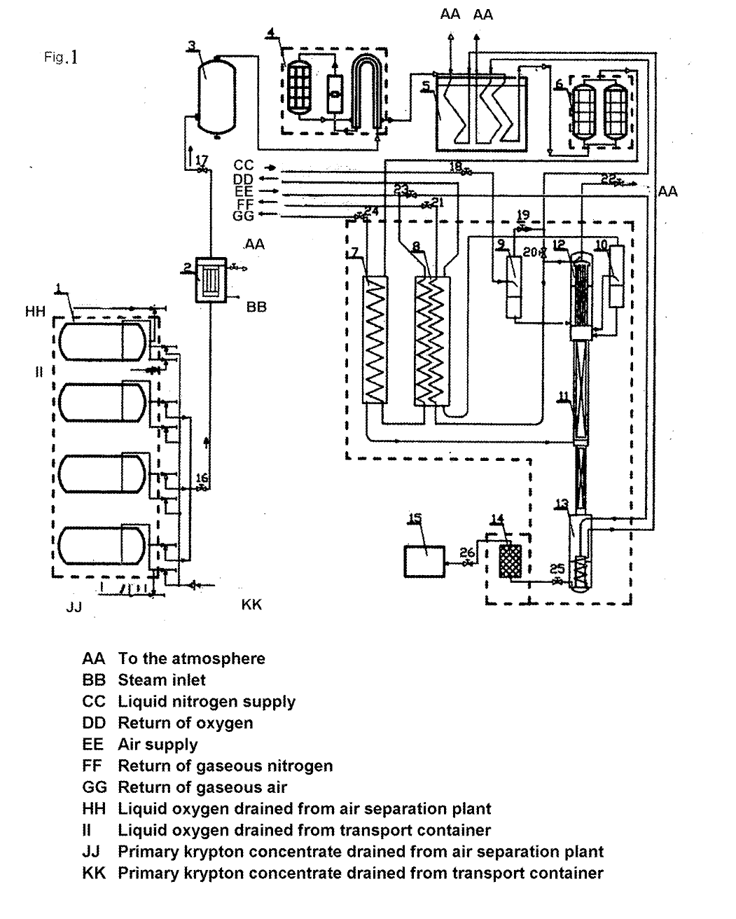

The invention is illustrated by the drawing in FIG. 1.

The drawing represents a functional diagram of the device fro producing a krypton/xenon mixture from a primary krypton concentrate, designed to implement the proposed method for producing a krypton/xenon mixture from a primary krypton concentrate.

### DESCRIPTION OF THE PREFERRED EMBODIMENT

The device for producing a krypton/xenon mixture from a primary krypton concentrate comprises a storage tank with a liquid primary concentrate 1, consisting of four reservoirs tied by a piping system to the armature so that they can work independently from each other in the process of receiving the liquid primary krypton concentrate from air-separation plants (ASU) or other external sources and its further utilization in the device.

Storage tank of the liquid primary concentrate 1 has corresponding low-temperature insulation and is equipped with appropriate control and automation tools.

Besides, the device for producing a krypton/xenon concentrate from a primary krypton concentrate consists of a vapor heat exchanger 2, a receiver 3, a hydrocarbon combustion unit 4, a water heat exchanger-cooler 5, a unit for adsorption purification from the combustion products 6, a main heat exchanger 7, a recuperative heat exchanger of the outgoing streams 8, a nitrogen separator 9, an oxygen separator 10, a rectification column 11, with a condenser 12 and an evaporator 13, a radon adsorber 14, a system of gasification and filling cylinders 15, valves 16 . . . 26 from the first to the eleventh, correspondingly.

In the device for producing a krypton/xenon concentrate from a primary krypton concentrate, the storage tank 1 is connected to the vapor heat exchanger 2, which is connected via pipes subsequently to the receiver 3, the hydrocarbon combustion unit 4, the coil of the primary concentrate of the water heat exchanger-cooler 5, the unit for adsorption purification from the combustion products 6, the intertubular space of the main heat exchanger 7, and further to the inlet of the rectification column 11. The top of the rectification column is connected via “input-output” pipes to the oxygen separator 10, the upper part of which, in its turn, is subsequently connected via pipes with the intertubular space of the recuperative heat exchanger of the outgoing streams 8 and to the line of oxygen return from the device.

In addition to the specified, the lower portion of the condenser 13 of the rectification column in connected via the pipeline to the radon adsorber 14 and further to the system of gasification and filling cylinders with a krypton/xenon mixture 15; storage tank 1 is connected to the vapor heat exchanger 2 the first valve 16; the lower part of the condenser 13 of the rectification column 11 is connected to the radon adsorber 14 by using the tenth valve 25 and further by using the eleventh valve—to the system of gasification and filling cylinders with krypton/xenon mixture 15; evaporator 13 has a built in coil which is connected to the line of air feed via the pipeline using the eighth valve 23, and the outlet is connected to the air coil of the water heat exchanger-cooler 5 and further on to the air discharge line to the atmosphere; a tubular space of the condenser 12 of the rectification column 11 is connected to the nitrogen discharge line to atmosphere using the seventh valve 22, and via the corresponding pipeline it is connected to the line which has the fifth valve 20 on one end, and, on the other end, the pipeline connected to the nitrogen coil of the heat exchanger of the outgoing streams 8 and further on through the sixth valve 21—to the return line of the gaseous nitrogen; lower part of the intertubular space of the condenser 12 is connected by the pipeline to the line of liquid nitrogen exit from the nitrogen separator 9, whose middle part is connected to the line of liquid nitrogen feed to the device by the third valve 18, and the upper part by means of the fourth valve 19 is connected to the pipeline which has the fifth valve 20 on one end, and with the other end it is connected to the inlet of the nitrogen coil of the water heat exchanger 5 and further on, to the nitrogen discharge line to the atmosphere; the vapor heat exchanger 2 is connected by means of pipes to the receiver 3 through the second valve 17, and the ninth valve 24 is mounted in the pipeline connecting the main heat exchanger 7 to the air return line.

The device is equipped with necessary control and measurement instruments, including flow rate meters, difference meters, level gauges, thermometers, pressure gauges and control monitors, as well as automatic control system (not shown in the Figure).

An exemplary embodiment of the claimed method on the device for its implementation is shown in FIG. 1.

A stream of liquid oxygen, containing krypton and xenon from an external air separation unit or from a transport canister, is directed to the reservoirs of the storage tank 1 and from there in the amount, corresponding to the unit production capacity, through the first valve 16, it is supplied for gasification to the vapor heat exchanger 2; after passing it, the primary concentrate already in the gaseous state is directed through the second valve 17 to the receiver 3 where its concentration uniform mixing and fluctuation leveling occur.

Further on the primary concentrate stream is directed to the hydrocarbon combustion unit 4, where it is purified from hydrocarbons on the catalyst at the temperature 500° C. Then the gaseous mixture is fed to the water heat exchanger-cooler 5 where it is cooled down to 5÷8° C. due to the cold of the outgoing streams of air through the ninth valve 24 and nitrogen. The primary concentrate, cooled down to the optimal temperature, is directed the adsorption purification unit 6, where its complete purification from the combustion products—carbon dioxide and water—takes place. The purified concentrate through the intertubular space of the main heat exchanger 7, where it is cooled down by the cold stream of air to the working temperature, is fed for separation to the rectification column 11. Separation of the primary concentrate and oxygen release take place in the rectification column; oxygen passes through the oxygen separator 10 where it is released from liquid in drops and further on, passing through the intertubular space of the recuperative heat exchanger of the outgoing streams 8, it gives away its cold to the direct air flow used in the process of cooing the concentrate in the main heat exchanger 7.

A recovered krypton/xenon concentrate is collected in the evaporator 13 of the rectification column 11. When the maximum specified level is achieved, there starts withdrawal of the krypton/xenon mixture at a rate that does not allow lowering below the specified minimum. Specified limits of the working level of the liquid allow control of the amount of vapor generated in the evaporator required for the rectification. Vapors are formed on the surface of the flooded coil. Inside the coil there is warm air which, at the outlet, gives away its cold to cool the concentrate in the heat exchanger-cooler 5. The extracted krypton/xenon concentrate, through the radon adsorber 14 and the eleventh valve 26, is directed to the system of gasification and idling cylinders 15.

Incondensable impurities (mainly, nitrogen) are also recovered from the upper part of the tubular space of the condenser 12 of the rectification column 11 which are discharged to the atmosphere through the seventh valve 22.

A liquid nitrogen, supplied to the nitrogen separator 9, where the separation of the gas phase occurs, which through the fourth valve 19 is directed to the water heat exchanger-cooler 5 to cool the primary concentrate, is used as a coolant medium of the first order in the device. Light portion of the liquid from the nitrogen separator 9 is directed to the intertubular space of the condenser 12 for oxygen condensation in its tubular part and refluxing for the rectification mode in the column 11. A gaseous portion of nitrogen, formed in the process of boiling liquid nitrogen in the intertubular space of the condenser 12 from the heat of the condensable oxygen transferred through the tube walls, is withdrawn from the upper part of the condenser 12 and divided into two parts. One part is withdrawn through the fifth valve 20, then it mixes with the gas phase of the nitrogen separator 9 and is directed to the water heat exchanger-cooler 5; the second part of the gaseous nitrogen is used to cool air in the heat exchanger 8 and is discharged from the device through the sixth valve 21.

The second order coolant medium is dry air, which is supplied to the device through the eighth valve 23 and is distributed between the coil of the evaporator 13 and the recuperative heat exchanger of the outgoing streams 8, in which the air takes the cold and transfers it to the concentrate in the main heat exchanger 7 and the heat exchanger-coolant 5.

Thus, in the proposed method and in the device implementing it, the desired technical result of extending the scope of use and enhancing functional capabilities, respectively, is achieved as they can be effectively used when the primary concentrate is in a liquid state and has high nitrogen content.

We claim:

1. A method of producing a krypton/xenon concentrate, comprising: purification of a stream of a gaseous primary concentrate using its catalytic combustion and a subsequent cooling, purification front catalytic combustion products, cooling after the purification from the catalytic combustion products, fractionation in a rectification column followed by a formation of a krypton/xenon mixture stream and a stripped oxygen stream and withdrawal of said krypton/xenon mixture stream as a target product from the rectification column, as well as purification of the krypton/xenon mixture from radon characterized by a fact that the stream of the gaseous primary concentrate is formed from a liquid primary concentrate, supplied from its sources by way of pouring the liquid primary concentrate into a storage tank with the subsequent feeding from it under pressure to a vapor heat exchanger for evaporation using a water vapor and formation of the gaseous primary concentrate; the pressure, under which the liquid primary concentrate is fed to the vapor heat exchanger, is set to a value sufficient for conducting subsequent steps for producing the target product; liquid nitrogen is used as a refrigerant for fractionation in the rectification column, and purification of the krypton/xenon mixture from radon is carried out at its exit from the rectification column.

2. The device for implementing the method in claim 1, comprising: the storage tank for the liquid primary concentrate, the vapor heat exchanger, a receiver, a hydrocarbon combustion unit, a water heat exchanger-cooler, a unit for adsorption purification from combustion products, a main heat exchanger, a recuperative heat exchanger of outgoing streams, a nitrogen separator, an oxygen separator, the rectification column with a condenser and an evaporator, a radon adsorber, a system of gasification and filling cylinders, valves from a first to an eleventh; moreover, the storage tank of the liquid primary concentrate is connected to a vapor heat exchanger by means of the first valve which, via pipes, is sequentially connected to the receiver, the hydrocarbon combustion unit, a coil of the primary concentrate of the water heat exchanger-cooler, the unit for adsorption purification from the combustion products, intertubular space of the main heat exchanger and further to an inlet to the rectification column whose upper part is connected via a pipeline “input/output” to the oxygen separator, whose upper part is sequentially connected via pipelines to the intertubular space of the recuperative heat exchanger of outgoing streams and to a line of oxygen return from the device; a lower part of the evaporator of the rectification column is connected to the radon adsorber by a pipeline and further, to a system of gasification and filling cylinders with a krypton/xenon mixture lower part of the evaporator of the rectification column is connected to the radon adsorber through a tenth valve, and further through the eleventh valve—to a system of gasification and filling cylinders with a krypton/xenon mixture; the evaporator has a built in coil, which is connected to an air feed line by the pipeline through an eighth valve, and its outlet is connected to an air coil of the water heat exchanger—evaporator by a pipeline and further—to an air discharge line to the atmosphere; a tubular space of the rectification column condenser is connected to a nitrogen discharge line to atmosphere through a seventh valve, and through a corresponding pipeline, it is connected to a line which has a fifth valve on one end and on another end—a pipeline, connected to a nitrogen coil of the heat exchanger of the outgoing streams and further through a sixth valve—to a line of gaseous nitrogen return, a lower part of the tubular space of the condenser is connected by a pipeline to a line of liquid nitrogen exit from the nitrogen separator whose middle part through a third valve is connected to the liquid nitrogen feed line to the device, and an upper part through a fourth valve is connected to a pipeline which has a fifth valve on one end and is connected by another end to an inlet of nitrogen coil of the water heat exchanger—cooler and further, to the nitrogen discharge line to the atmosphere: the heat exchanger is connected via pipelines to the receiver through a second valve, and a ninth valve is mounted in a pipeline connecting the main heat exchanger to a line of oxygen return.

3. The device in claim 1 is characterized that said storage tank for the liquid primary concentrate is constructed in a form of four reservoirs connected through a corresponding valve to a vapor heat exchanger inlet.

4. The device in claim 2 is characterized that activated carbon or silica gel or aluminum oxide or zeolite NaX is used as a radon entrapping sorbent in the radon adsorber.
